(19) United States
(12) Patent Application Publication
(10) Pub. No.: US 2009/0278457 A1
(43) Pub. Date: Nov. 12, 2009

(54) METAL HALIDE LAMP

(75) Inventors: Vincent Fischer, Eindhoven (NL); Oscar Gerard Stappers, Eindhoven (NL); Jacobus Johannes Franciscus Gerardus Heuts, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/912,392

(22) PCT Filed: Apr. 24, 2006
(86) PCT No.: PCT/IB06/51264

§ 371 Date: Oct. 24, 2007

(30) Foreign Application Priority Data
Apr. 29, 2005 (EP) 05103586.3

(51) Int. Cl. H01J 61/18; H01J 61/20

(52) U.S. Cl. 313/640; 313/638

(57) ABSTRACT

The invention relates to a metal halide lamp (1) combining a high luminous efficacy and a high red rendering. This is realized by a lamp comprising a discharge vessel (10) with a ceramic wall, the discharge vessel enclosing a discharge space (11) which contains two electrodes and an ionisable filling, which filling contains at least 20 mol % of a Ca-halide, and one or more halides selected from the group of T1 and the rare earths, wherein the ionisable filling comprises Mg-halide, Mn-halide, or a mixture thereof in a molar quantity of at least 5 mol %, and preferably between 10 and 15 mol % of the total quantity of halides.

The invention relates to a metal halide lamp comprising a discharge vessel with a ceramic wall, the discharge vessel enclosing a discharge space which contains two electrodes and an ionisable filling comprising halides, which filling contains at least about 20 mol % of a Ca-halide and one or more halides selected from the group of Tl and the rare earths.

Arc discharge lamps are more and more used to replace incandescent lamps in interior and exterior lighting. However, arc discharge lamps do not render red colors as satisfactorily as incandescent light sources. To increase the red radiation, a Ca-halide is often added to the filling. One or more halides selected from the group of Tl and the rare earths are added as green radiators to obtain a white light source and to further improve the luminous efficacy. Rare-earth metals are herein understood to mean the elements Sc, Y and the lanthanides. Na may be further included for its highly efficient radiation at color temperatures of around 3000 K.

As specified by the Commission Internationale de l'Eclairage (CIE) in CIE publication number 13.2, the R₉ color rendering index represents a comparison between the reflected intensities of a standardized red test sample when viewed separately with two light sources, a test source and a reference source. For test sources of a correlated color temperature (CCT) of less than 5000 K, the reference source is blackbody radiation of equal CCT and luminance. The more identical the two reflected intensities of the red test sample, the higher the R₉ value. A maximum value of 100 represents a light source that renders the specified red test sample identical to the reference source.

The word “ceramic” is herein understood to mean a refractory material such as a monocrystalline metal oxide (e.g. sapphire), polycrystalline metal oxide (e.g. polycrystalline densely sintered aluminum oxide and yttrium oxide), and polycrystalline non-oxide material (e.g. aluminum nitride). Such materials allow wall temperatures of 1500-1700 K and resist chemical attacks by halides and Na. In the present invention, polycrystalline aluminum oxide (PCA) has been found to be most suitable.

A lamp of the type defined in the opening paragraph is known from US 2003/0141818 A1. In order to produce a lamp with an increased red emission, a quantity of between 10 and 75 mol % of CaI₂ is added to the arc tube filling of the lamp of US 2003/0141818 A1. TlI is included in the filling in order to limit the relative contribution of the blue radiation and to preferentially enhance the red calcium radiation. AlI₃ or GaI₃ are added to increase the quantity of calcium in the gas phase, thereby also increasing the amount of red radiation. However, this known lamp has the disadvantage of a relatively low luminous efficacy (60-70 lm/W) due to the specific type of salt mixes used and the high reactivity of Al towards the tungsten metal of the electrodes; this has a negative influence on the service life of the known lamp.

It is an object of the invention to provide a lamp of the type described in the opening paragraph, having a high luminous efficacy and a high red rendering.

According to the invention, this object is achieved in that the ionisable filling further comprises Mg-halide, Mn-halide or a mixture thereof in a molar quantity of at least about 5 mol %, and preferably between about 10 and about 15 mol % of the total quantity of halides. In the lamp of the invention, the recognition is utilized that magnesium and manganese increase both the amount of red radiation and the luminous efficacy of the lamp by radiating close to 520 nm. Below about 5 mol %, the effect of Mg-halide, Mn-halide, or a mixture thereof is too small to contribute significantly to the improvement of the color properties. Above about 15 mol % of these halides, the luminous efficacy decreases and the color of the lamp shifts away from the blackbody line.

In the lamp of the invention, calcium halide is present in a quantity of at least about 20 mol %. An even better red rendering is obtained when calcium is present in a quantity of at least about 50 mol %.

One or more halides selected from the group of Tl and the rare earths are added as green radiators to the filling. Particularly preferred green radiators are the halides of cerium and praseodymium. The quantity of halides from the group of Tl and the rare earths is preferably between about 0.5 and about 15 mol %. Below about 0.5 mol %, their contribution to the luminous efficacy is insignificant, while a quantity of more than about 15 mol % causes an unacceptable contraction of the arc.

To increase the lamp voltage, and thus its light output, the filling may further contain Hg to provide an adequate voltage drop or power loading between the electrodes. The use of Hg has the advantage that a high-pressure Ar (or other noble gas) filling to obtain a suitable voltage drop can be avoided. The quantity of Hg needed for a certain lamp voltage depends primarily on the distance between the electrodes and the volume of the lamp discharge space and secondarily on the type of salt fill used.

The lamp of the invention has a correlated color point of more than 4000 K; its color lies close to the blackbody line, shows good color and red rendition and has an improved maintenance behavior throughout its life.

These and other aspects of the invention are apparent from and will be elucidated with reference to the embodiments described hereinafter.

In the drawings,

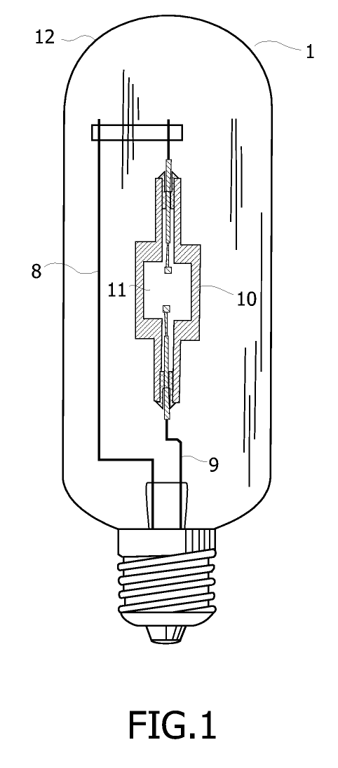

FIG. 1 shows a lamp according to the invention.

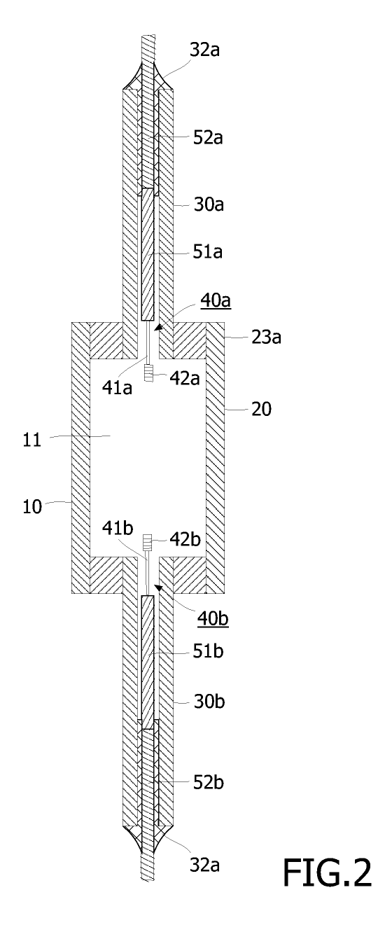

FIG. 2 is a cross-section of a discharge vessel of the lamp shown in FIG. 1.

FIG. 1 shows a metal halide lamp 1 comprising a discharge vessel 10 shown in a cross-section and not drawn to scale in FIG. 2 and having a ceramic wall enclosing a discharge space 11 which contains an ionisable filling, which, in addition to Hg, contains NaI, CaI₂, CeI₃ and MgI₂.

The discharge vessel is shown in detail in FIG. 2. The discharge vessel has a ceramic wall 20, which is provided at either end with a projecting ceramic plug 30a, 30b for accommodating electric lead-throughs to the electrodes 40a and 40b, respectively. Each lead-through comprises a halide-resistant portion 51a, 51b made of, for example, Mo and a portion 52a, 52b which is connected to a respective plug 30a, 30b in a gas-tight manner by means of, for example, a ceramic glaze connection 32a, 32b. Halide-resistant is herein understood to mean that no or substantially no corrosive attack by halides and free halogens takes place under the conditions prevailing in the discharge space during lamp operation.

The portions 52a, 52b are made of a metal corresponding to that of the projecting plugs and having a corresponding coefficient of expansion. For example, Nb is a very suitable material. The portions 52a, 52b are connected to the current conductors 8, 9, respectively, as shown in FIG. 1.

Each electrode 40a, 40b comprises an electrode rod 41a, 41b and is provided with a winding 42a, 42b at one end.

The discharge vessel 20 encloses a discharge space 11 in which the filling ingredients are present.

In one embodiment of the lamp according to the invention, the discharge vessel is made of polycrystalline densely sintered aluminium oxide, as are the projecting plugs. The electrodes are made of tungsten. The rated power of the lamps used in the present embodiment is 82.5 W. The quantities of the filling components are given in Table 1. In addition, the lamp comprises 400 mbar Ar/Kr85 as a starter gas. The outer bulb is made of hard glass.

TABLE 1

| | | | mol % | mol % | mol % | mol % |
|---|---|---|---|---|---|---|
| Lamp | mg Hg | mg salt | NaI | CaI₂ | CeI₃ | MgI₂ |
| 1 | 6.18 | 10.35 | 15.5 | 59.5 | 7.4 | 17.5 |
| 2 | 6.17 | 9.49 | 17.2 | 57.2 | 8.1 | 17.5 |
| 3 | 5.93 | 8.32 | 17.2 | 67.7 | 5.7 | 9.4 |
| 4 | 6.08 | 7.74 | 18.7 | 65.6 | 6.2 | 9.4 |
| 5 | n.a. | 7.27 | 15.3 | 65.2 | 5.1 | 14.4 |
| A | 6.09 | 9.35 | 17.5 | 76.9 | 5.7 | 0 |
| B | 5.86 | 8.14 | 18.8 | 75 | 6.3 | 0 |
| C | 5.95 | 8.53 | 17.9 | 76.2 | 6.0 | 0 |
| D | 5.90 | 8.94 | 17.0 | 77.4 | 5.7 | 0 |

n.a. = not available

The discharge vessel has an internal diameter of 5.6 mm and an internal length of 8 mm. The distance between the electrodes is 6 mm.

Table 2 shows performance data for the experimental embodiments described above.

TABLE 2

| Lamp | v (V) | i(A) | w(W) | Lm/W | x | y | Tc | Ra | R9 |
|---|---|---|---|---|---|---|---|---|---|
| 1 | 115.8 | 0.718 | 82.6 | 105.77 | 0.3687 | 0.3858 | 4387 | 89.6 | 60.4 |
| 2 | 119.0 | 0.698 | 82.4 | 101.29 | 0.369 | 0.3871 | 4386 | 89.8 | 63.0 |
| 3 | 109.7 | 0.755 | 82.5 | 108.27 | 0.362 | 0.3725 | 4511 | 85.6 | 38.0 |
| 4 | 107.2 | 0.772 | 82.5 | 107.36 | 0.3606 | 0.3742 | 4563 | 85.4 | 37.6 |
| 5 | 109.5 | 0.756 | 82.5 | 106.22 | 0.3605 | 0.373 | 4560 | 86.4 | 41.8 |
| average | 112.24 | 0.740 | 82.5 | 105.8 | 0.364 | 0.379 | 4481 | 87.4 | 48.2 |

For purposes of comparison, the performance of lamps according to the state of the art, identical to lamps of the type according to the invention, but without Mg in the filling, is shown in Table 3. Both lamps were operated at a system voltage of 230V.

TABLE 3

| Lamp | v (V) | i(A) | w(W) | Lm/W | x | y | Tc | Ra | R9 |
|---|---|---|---|---|---|---|---|---|---|
| A | 101.6 | 0.814 | 82.6 | 108.27 | 0.3572 | 0.3637 | 4619 | 76.6 | −6.6 |
| B | 99.3 | 0.832 | 82.4 | 111.55 | 0.3582 | 0.3752 | 4643 | 76.6 | −8.6 |
| C | 101.8 | 0.812 | 82.4 | 105.58 | 0.3602 | 0.3715 | 4562 | 79.6 | 14.1 |
| D | 102.9 | 0.804 | 82.5 | 103.65 | 0.3629 | 0.3724 | 4483 | 81.0 | 19.9 |
| average | 101.4 | 0.816 | 82.5 | 107.3 | 0.360 | 0.371 | 4577 | 78.5 | 4.7 |

It is evident that the lamps according to the invention have a better luminous efficacy (Lm/W) than the lamps known from US 2003/0141818 A1 with a luminous efficacy of at most 91 Lm/W. Comparison of Tables 2 and 3 shows that the general color rendering index Rₐ and the red rendering index R₉ are improved by the addition of MgI₂ without a significant effect on the luminous efficacy. The x and y-coordinates on the x-y chromaticity diagram of the CIE system show that the color of the lamps according to the invention is closer to the blackbody line.

Another embodiment with a discharge vessel of 4×19 mm (inner diameter×length of the vessel) was filled with 6.2 mg of iodides in a ratio of 62.2 mol % NaI, 2.1 mol % TlI, 20.6 mol % CaI₂, 2.3 mol % CeI₃ and 12.8 mol % MnI₂. The discharge vessel contained no Hg, but was filled with Xe to a pressure of 30 kPa and mounted in a vacuum bulb 12. At a power setting of 90 Watts, a color rendering index R₉ of 31.6 and a luminous efficacy of 100 Lm/W were measured.

Another feature of the lamps according to the invention is their improved maintenance behavior throughout life.

The protective scope of the invention is not limited to the embodiments described hereinbefore by way of example. The invention is defined by each and every novel characteristic feature and each and every combination of characteristic features. Reference numerals in the claims do not limit the protective scope of the invention. Use of the verb “comprise” and its conjugations does not exclude the presence of elements other than those mentioned in the claims. Use of the indefinite article “a” or “an” preceding an element does not exclude the presence of a plurality of such elements.

Any reference signs in the claims shall not be construed as limiting the claim.

1. A metal halide lamp (1) comprising a discharge vessel (10) with a ceramic wall, the discharge vessel enclosing a discharge space (11) which contains two electrodes and an ionisable filling comprising halides, which filling contains at least about 20 mol % of a Ca-halide and one or more halides selected from the group of Tl and the rare earths, characterized in that the ionisable filling comprises Mg-halide, Mn-halide, or a mixture thereof in a molar quantity of at least about 5 mol % of the total quantity of halides.

2. A lamp as claimed in claim 1, wherein the Mg-halide, Mn-halide, or a mixture thereof is present in a molar quantity of between about 10 and about 15 mol % of the total quantity of halides.

3. A lamp as claimed in claim 1, wherein the filling further comprises Hg.

4. A lamp as claimed in claim 1, wherein the filling further comprises a Na-halide.

5. A lamp as claimed in claim 1, wherein the rare earths are cerium and praseodymium.

6. A lamp as claimed in claim 1, wherein the filling contains at least about 50 mol % of a Ca-halide
